(19) United States
(12) Patent Application Publication
(10) Pub. No.: US 2015/0208121 A1
(43) Pub. Date: Jul. 23, 2015

(54) SYSTEM AND COMPUTER PROGRAM FOR PROVIDING A/V OUTPUT

(71) Applicant: Cameron Mason Farnum, Austin, TX (US)

(72) Inventor: Cameron Mason Farnum, Austin, TX (US)

(21) Appl. No.: 14/158,801

(22) Filed: Jan. 18, 2014

(51) Int. Cl. H04N 21/4363; H04N 21/6371; H04N 21/647; H04N 21/63

(52) U.S. Cl. CPC H04N 21/43637; H04N 21/632; H04N 21/6371; H04N 21/64707; H04N 21/64753

(57) ABSTRACT

A system and computer program product for providing audio. The computer program product includes associating output from each of the one or more A/V devices with a unique identifier, receiving the associated output from the one or more A/V devices, initializing wireless communication with one or more remote devices, receiving information, from one or more remote devices, identifying the associated output from the one or more A/V devices, and streaming the identified associated output from the one or more A/V devices to the respective one or more remote devices.

### BACKGROUND OF THE INVENTION

1. Field of the Invention

The present invention is generally related to providing audio/visual (“A/V”) output, and more particularly to a system and computer program and for providing A/V output.

2. Discussion of the Background

The output from an A/V device is sometimes inconvenient to be communicated to all patrons to an establishment. For instance, the audio output from a television may be distracting if it played from a normal speaker system to all customers of an establishment. However, current technology commonly involves turning off the sound entirely without the ability to localize such output. Commonly, the customers of an establishment carry devices with audio, video, and/or display capabilities. But these devices aren't utilized and there exists no integration with A/V devices in such establishments.

Thus, there currently exist deficiencies in the field of A/V devices, and, in particular, with providing output from one or more A/V devices.

### SUMMARY OF THE INVENTION

Accordingly, one aspect of the present invention is to provide a computer program product embodied on a non-transitory computer readable medium for providing output from one or more A/V devices. The computer program is implemented by one or more processors executing processor instructions. The computer program product includes (i) a first computer code for associating output from each of the one or more A/V devices with a unique identifier, (ii) a second computer code for receiving the associated output from the one or more A/V devices, (iii) a third computer code for initializing wireless communication with one or more remote devices, (iv) a fourth computer code for receiving information, from one or more remote devices, identifying the associated output from the one or more A/V devices, and (v) a fifth computer code for streaming the identified associated output from the one or more A/V devices to the respective one or more remote devices.

Another aspect of the present invention is to provide a system for providing output from one or more A/V devices. The system includes (a) a plurality of remote devices, (b) a media device in communication with the one or more A/V devices, (c) a network interface in communication with the media device and the plurality of remote devices over a wireless network configured to provide output from the one or more A/V devices, and (d) a shared database in communication with the communication device. The media device is configured to: (i) associate output from each of the one or more A/V devices with a unique identifier, (ii) receive the associated output from the one or more A/V devices, (iii) initialize wireless communication with one or more remote devices, (iv) receive information, from one or more remote devices, identifying the associated output from the one or more A/V devices, and (v) stream the identified associated output from the one or more A/V devices to the respective one or more remote devices.

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIGS. 1A-1G are block diagrams illustrating a system for providing A/V output in accordance with an embodiment of the present invention;

FIG. 2 is a flow chart illustrating a method for providing A/V output in accordance with an embodiment of the present invention; and

FIGS. 3A-3B illustrate exemplary remote device user interfaces for providing A/V output in accordance with an embodiment of the present invention.

### DETAILED DESCRIPTION OF THE PREFERRED EMBODIMENTS

Referring now to the drawings, wherein like reference numerals designate identical or corresponding parts throughout the several views, preferred embodiments of the present invention are described.

The present invention relates to hardware and/or software that connects to one or more audio/visual (A/V) devices and streams output associated with those A/V devices to one or more remote devices, which may be without limitation owned by (i) an establishment/location where the A/V device is located, (ii) by a client, patron, or customer of the establishment/location, or (iii) any other party. The A/V device includes any device that provides audio and/or video output (and/or receives audio and/or video input), such as without limitation a television, video monitor, stereo, CD, blue ray, DVD, VCR, telephone, cable box, satellite receiver, internet device, and the like. According to one embodiment, the A/V device is a television or video monitor (sometimes collectively or individually referred to herein as “television”). The output from the A/V device is streamed to one or more remote devices over a wired/wireless protocol, such as without limitation Bluetooth, Wi-Fi 802.11, and the like. The output is communicated from the A/V device to one or more remote devices by means of hardware and/or software which may be internal and/or external to the A/V device.

Remote devices include without limitation any tablets, laptops, computers, cell phones, PDA, portable gaming devices, portable speakers and other smart devices with audio, video, and/or display capabilities. Remote devices may also include an apparatus configured to receive wired/wireless transmissions arranged to operate with the present invention, such as desk top speaker systems.

These remote devices are commonly portable mobile devices, but non-portable devices are within the scope of the present invention in alternate embodiments. The customers of an establishment/location carry mobile devices with audio, video, and/or display capabilities. But these mobile devices aren't utilized and there exists no integration with A/V devices in such establishments/locations.

According to the present invention, an internal or external hardware and/or software unit (herein referred to as the “Live Audio System”) is responsible for receiving the audio/video output from the A/V device. The Live Audio System may optionally be arranged to receive other output from the A/V device such as without limitation meta-data information. The Live Audio System may include a wireless transmitter and/or receiver and may be configured to communicate over a network such as the Internet, using either a wired or wireless arrangement.

According to one embodiment, the Live Audio System is an external device connected to one or more audio/video output connecters (e.g., digital output, audio jack output, USB, etc.) of the A/V device. According to an alternate embodiment, the Live Audio System is connected to a non-audio/video output connector, such as via an internet connector and the like. The Live Audio System includes the software and/or hardware necessary to receive the output from the A/V device and stream the audio/video output over a wired/wireless protocol. However, it is understood that an external device is not required and that the Live Audio System may be integrated into the A/V device itself. According to one arrangement, the Live Audio System may be connected to multiple A/V devices and the output of which may be accessed individually and/or collectively on one or more remote devices.

According to an alternate embodiment, one or more A/V devices and/or Live Audio Systems communicate with a Live Audio System Hub. Under this embodiment, the Live Audio System Hub communicates with one or more remote devices rather than the Live Audio System. The Live Audio System Hub includes similar capabilities as the Live Audio System in the non-alternative embodiment as discussed herein and may include a wireless transmitter and/or receiver and may be configured to communicate over a network such as the Internet, using either a wired or wireless arrangement.

The one or more remote devices include hardware and/or software for receiving the output communicated from the external device. Live Audio System. According to one embodiment, the one or more remote devices include a software application that allows a user to tune to a particular A/V device and receive audio/video output over the wired/wireless protocol and play back the audio/video output on the one or more remote devices. For instance, the audio output from a television may be communicated using the Live Audio System and output on without limitation the speakers, headphone jacks, and the like of without limitation a remote device. This might be particularly useful without limitation at a gym, waiting room, bar, restaurant and the like where sound from a A/V device might not be heard or where the output is not desired to be broadcast to everyone in that particular area.

If there are more than one A/V devices being connected to the system of the present invention, then each relevant A/V device might be labeled with indicia, such as a number, so that the user would be able to select and stream the appropriate A/V device. For instance, a gym might have several televisions each displaying different video output. Each television could be labeled with a number so that the patron would know which television audio feed to listen to. The remote device application would allow selection of the audio feed based identifying number. According to one embodiment, each Live Audio System includes a display, such as an LED or the like, which can be used to display the relevant indicia to uniquely identify the A/V device. Under such an embodiment, the Live Audio System would typically be placed in close proximity to the A/V device and visual to the users of the system, such as without limitation attached to the top, side, bottom or front face of the A/V device.

According to one embodiment, the audio/video output is password protected so that only devices having the appropriate permission may receive such output. Such an arrangement may be configured to allow only patrons of a particular establishment to tune in the audio/video output.

According to one embodiment, there is no recording of the audio feed nor is there pausing of it. No manipulation of the audio feed as provided in FCC regulations. The audio is simply played on the remote device. However, this is not intended in any way as a limitation, and other arrangements are possible within the scope of the present invention.

The Live Audio System enables patrons of an establishment to be able to hear the audio content from a television where the audio output cannot be heard due to the volume being turned off or lowered on the television or the ambient noise being too loud to hear. The owners of the establishment can control and monitor the patron's use of the Live Audio System.

According to one embodiment, the hardware of the Live Audio System includes without limitation the hardware required to connect to one or more A/V device and stream the audio/video output of such over a wired/wireless protocol. However, it is understood that portions of the hardware may be performed using software instead.

According to one embodiment, the one or more remote devices include a software application which allows a user to connect to the Live Audio System over the wired/wireless protocol, tune to the audio/video output to a particular A/V device, and playback the audio/video output through the remote device's audio/video output.

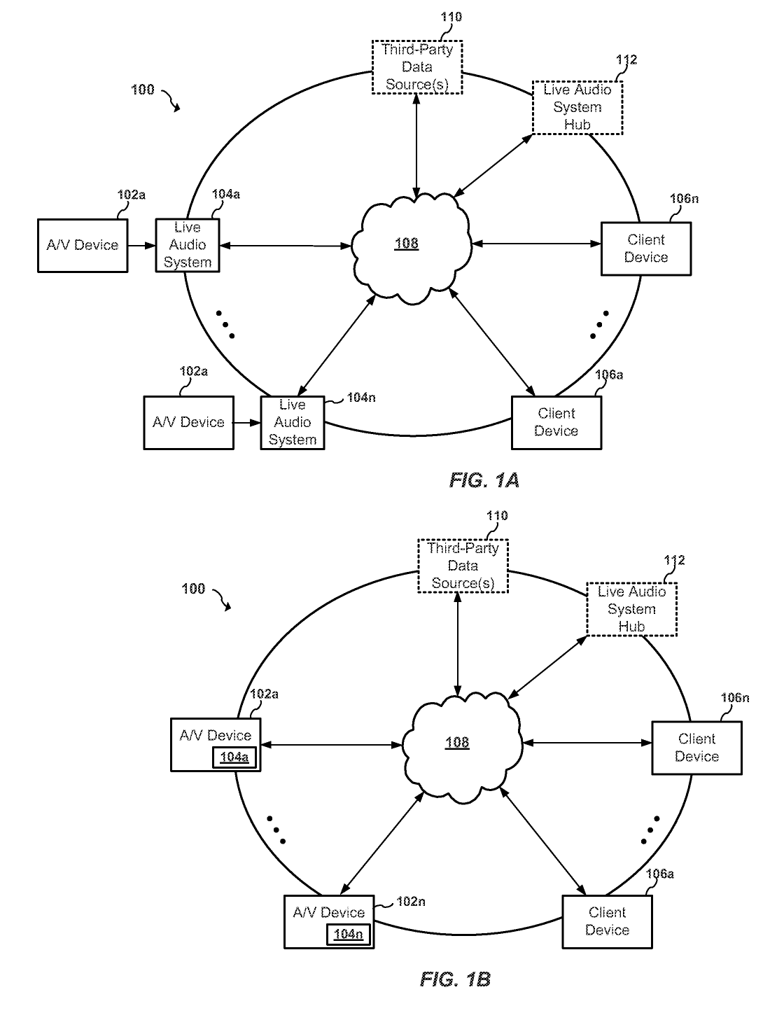

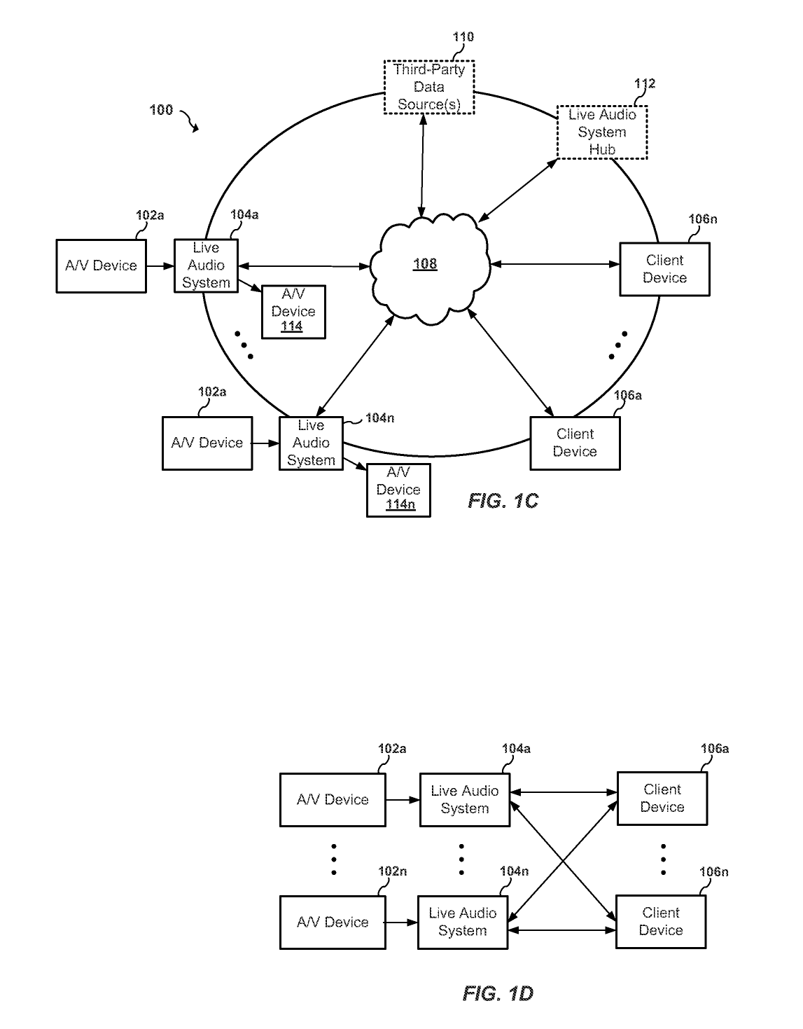

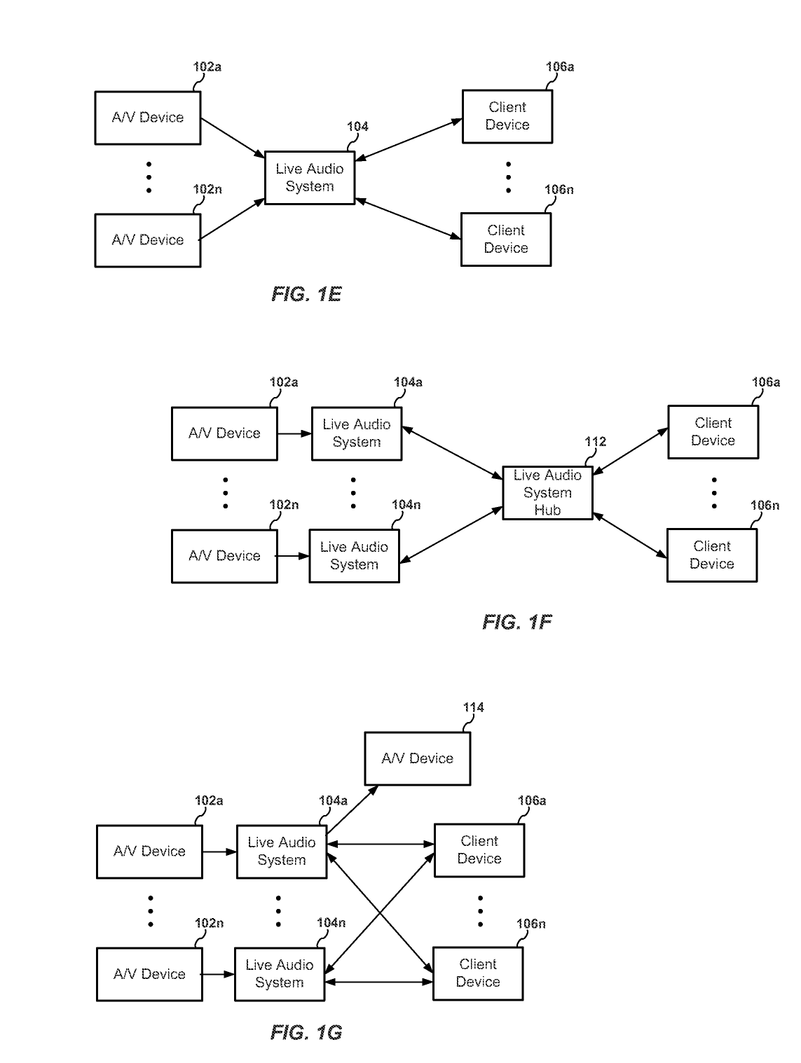

Referring to FIGS. 1A-1G, block diagrams illustrating a system for providing A/V output in accordance with an embodiment of the present invention are shown. One or more A/V devices (102a-102n) either directly (FIG. 1B) or indirectly (FIG. 1A) communicate over a wired/wireless network/protocol 108 with one or more remote devices (106a-106n) via one or more Live Audio System 104. FIG. 1A shows the Live Audio System 104 as an external device through which the one or more A/V devices (102a-102n) indirectly communicate with the one or more remote devices (106a-106n) over a wired/wireless network/protocol 108. FIG. 1B shows an alternate arrangement in which the Live Audio System 104 is integrated into the one or more respective A/V devices (102a-102n), which directly communicate with the one or more remote devices (106a-106n) over a wired/wireless network/protocol 108.

FIG. 1C shows an alternate arrangement in which the Live Audio System 104 communicates at least a portion of the audio/video output from the one or more respective A/V devices (102a-102n) to one or more other A/V devices 114. According to this alternate embodiment, the one or more A/V devices (102a-102n) might be without limitation a cable box, an audio box, and the like, and the one or more A/V devices 114 might be without limitation a television, monitor, speaker and the like. The Live Audio System 104 receives audio/video output from the one or more A/V devices (102a-102n) and communication a portion of such audio/video output to the one or more A/V devices 114. Under this alternate arrangement, the video and audio may be output at different times to account for delays in the wired/wireless network/protocol 108. For instance, if the video output portion from the one or more A/V devices (102a-102n) is streamed to a directly connected to a video display (114) and the audio portion is communicated to the one or more remote devices (106a-106n) over a wired/wireless network/protocol 108 having low a bandwidth or operating in a less than real-time environment (such as a slow Internet connection), then the audio portion would play noticeably behind the video stream. To accommodate this, the video output may be buffered by the Live Audio System 104 (and/or the Live Audio System Hub 112) and then displayed on the video display (114) after a delay to better synchronize the audio and video output. This delay could be calculated based upon timing results between the Live Audio System 104 (and/or the Live Audio System Hub 112) and the one or more remote devices (106a-106n). This delay could also be manually set by the user using a graphical user interface.

According to one embodiment, as shown in FIG. 1D, each A/V device (102a-102n) is connected to a Live Audio System (104a-104n), which communicates with one or more remote devices (106a-106n). The Live Audio System (104a-104n) may communicate at least a portion of the audio/video output to one or more other A/V devices 114 as described herein.

According to another embodiment, as shown in FIG. 1E, one or more A/V devices (102a-102n) are connected to a Live Audio System 104, which communicates with one or more remote devices (106a-106n). According to yet another embodiment, as shown in FIG. 1F, each A/V device (102a-102n) is connected to a respective Live Audio System (104a-104n), which is in communication with one or more Live Audio System Hubs 112. In this embodiment, the one or more Live Audio System Hubs 112 are in communication with one or more remote devices (106a-106n). However, other combinations are possible within the scope of the present invention, including without limitation, incorporating the hardware and/or software associated with the Live Audio System 104 in either the A/V devices (102a-102n) and/or remote devices (106a-106n).

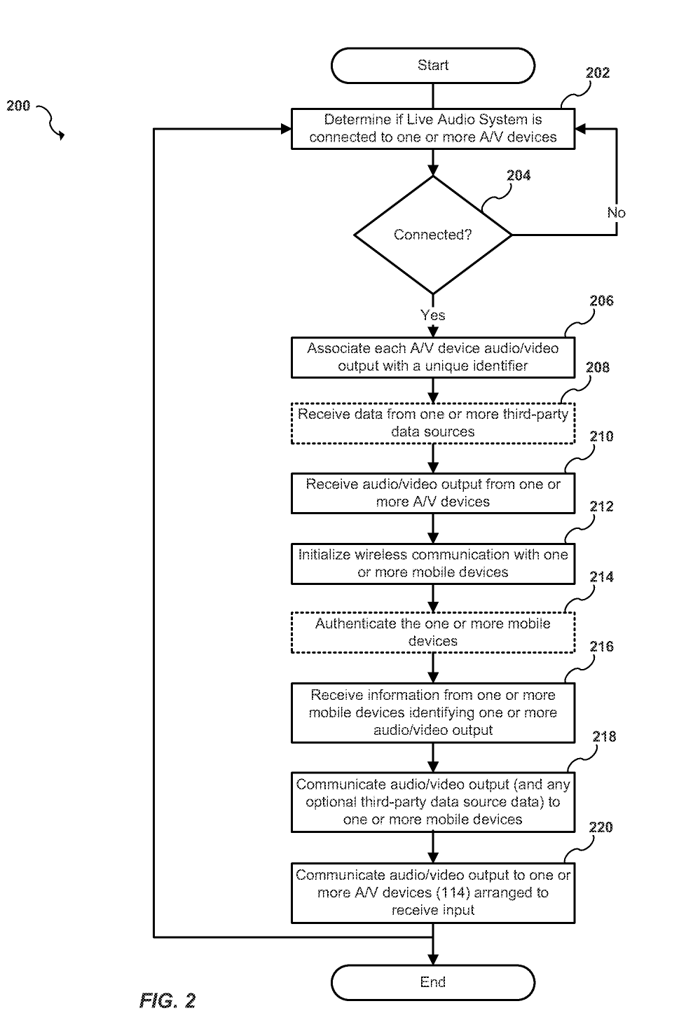

Referring to FIG. 2, a flow chart illustrating a method for providing A/V output in accordance with an embodiment of the present invention is shown. At blocks 202-204, it is determined whether the Live Audio System 104 is connected to one or more A/V devices (102a-104n). If the Live Audio System 104 is not connected, then the system continues to wait for one or more A/V devices (102a-102n) connections. Otherwise, if the Live Audio System 104 is connected, then processing continues at block 206. At block 206, a unique identifier is associated with each audio/video output from each connected A/V device(s) (102a-104n).

Optionally, data is received from one or more third-party data sources 110 at block 208. The data may be in the form of an audio and/or video stream, text, graphics, animation and the like. The received data is later communicated to the one or more remote devices (106a-106n) (see step 218 described below). The one or more third-party data sources 110 includes any data received from any third party for use by the present invention and may include without limitation local/regional information, emergency informs data feed, or paid advertisements. The information/data related to the audio/video output may include without limitation live blog feeds, web pages and the like which discuss or relate to the specific audio/video output. Emergency information may include without limitation emergency weather alerts and other emergency related broadcast information.

Closed captioning information may include without limitation closed captioning data in real or near real-time that is synchronized with the specific audio/video output. Closed captioning information may be without limitation decoded from the digital and/or analog output stream received from the one or more A/V devices (102a-102n or 114) and sent to the one or more remote devices (106a-106n), where such captioning information is displayed and synchronized with the audio and/or video received from the one or more A/V devices (102a-102n or 114). Closed captioning information may also be without limitation translated/determined from the audio stream received from the one or more A/V devices (102a-102n or 114) using speech to text recognition software in real or near real-time and then sent to the one or more remote devices (106a-106n), where such captioning information is displayed and synchronized with the audio and/or video received from the one or more A/V devices (102a-102n or 114).

Local/regional information may include without limitation local news or other regional information, and the like. Local/regional information may also include data/information provided by the owner of the establishment where the present invention is implemented, such as data/information related to the establishment. For instance, if the A/V device (102a-102n) is located in a waiting room, then the data/information might be the number of the next person to be seen. If the A/V device (102a-102n) is located in a restaurant/bar, then the data/information might be menu information for the establishment. Paid advertisements include without limitation advertisement text/graphics/animation that is similar to click ads used in web pages on Internet.

The audio/video output is received from one or more A/V devices (102a-102n) at block 210. At block 212, wired/wireless communication is established between the Live Audio System 104 and one or more remote devices (106a-106n). This may optionally include authentication of the wired/wireless connection, at block 214. Such authentication may include without limitation use of a password and/or password, encryption and the like. At block 216, information identifying one or more audio/video output from one or more A/V devices (102a-102n) is received from one or more remote devices (106a-106n). A user uses a software application on their remote device (106a-106n) to select the appropriate audio/video output. Such selection may be by means of without limitation a graphical user interface provided by a software application running on the remote device (106a-106n) which provides a scrollable list of audio/video output available. The user may also manually enter an identifier associated with the A/V device (102a-102n) and/or output from the A/V device (102a-102n).

Audio/video output associated with the selected identifier is streamed to the remote device (106a-106n), at block 218. Any data received from one or more third-party data sources 110 (see optional step 208 described above), may be communicated to the remote device along with the audio/video output. For instance, the audio/video output may be an audio feed from a television or other A/V device and the data received from one or more third-party data sources 110 may be fun facts about the specific audio/video output or paid advertisements. The audio stream might be without limitation output on the speakers of the one or more remote devices (106a-106n) and the fun facts about the specific audio/video output or paid advertisements displayed visually on the display of the one or more remote devices (106a-106n). Obviously, other combinations are possible within the scope of the present invention.

Optionally, at block 220, audio/video output associated with the selected identifier is streamed to one or more A/V devices 114. According to this alternate embodiment, one or more A/V devices (102a-102n) might be without limitation a cable box, an audio box, and the like, and the one or more A/V devices 114 might be without limitation a television, monitor, speaker and the like. The Live Audio System 104 receives audio/video output from the one or more A/V devices (102a-102n) and communication a portion of such audio/video output to the one or more A/V devices 114. FIG. 1C, shows a non-limiting example of such an arrangement.

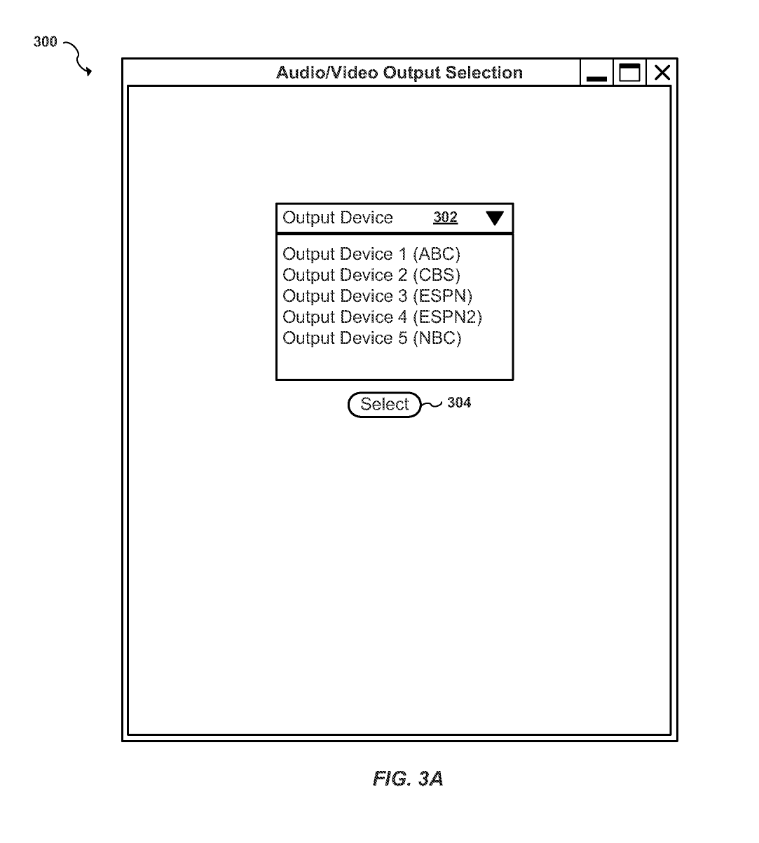

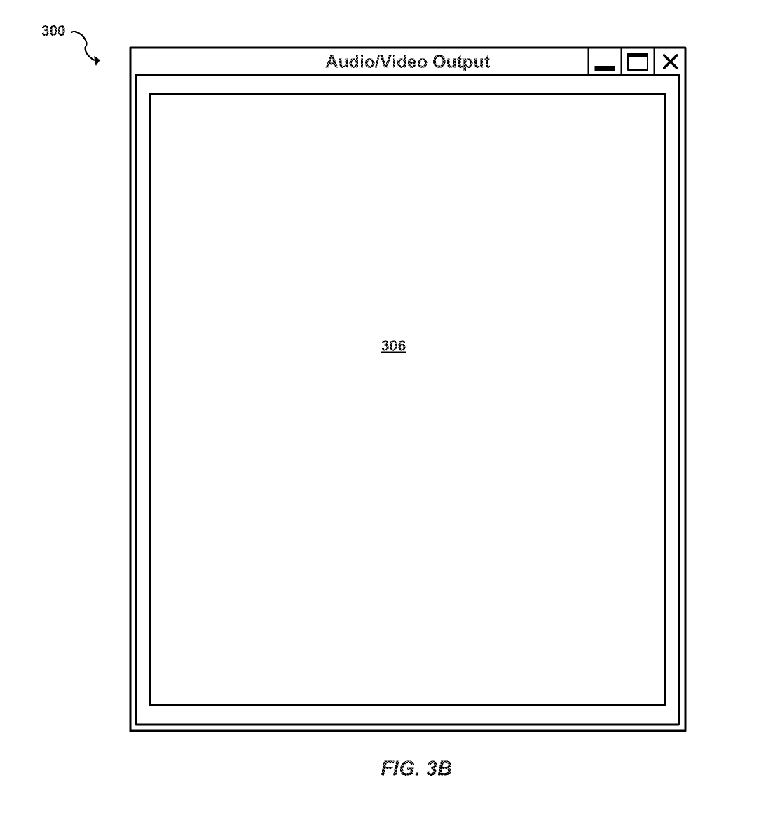

Referring to FIGS. 3A-3B, exemplary remote device user interfaces for providing A/V output in accordance with an embodiment of the present invention are shown. According to one possible implementation, a user selects output from one or more A/V devices (102a-102n) using a graphical user interface 300 using a pull-down list 302 and associated button 304. The selected output may then be played on the remote device. If the selected output includes video, then it can be displayed in display area 306. If data/information is received from the optional third-party data sources, then such data/information can be displayed in display area 306. For instance, the audio feed from the one or more A/V devices (102a-102n) may be played on the speakers of the respective remote device (106a-106n) while a paid advertisement or other data/information received from a third-party data source 110 is displayed in display area 306.

According on an alternate embodiment, the user can select to receive output from multiple A/V devices (102a-102n). According to this embodiment, the user could without limitation listen to one A/V device (102a-102n) on a speaker of the remote device (106a-106n) while simultaneously watching another A/V device (102a-102n) on the remote device (106a-106n).

While the present invention has been described reference to one or more particular embodiments, those skilled in the art will recognize that many changes may be made thereto without departing from the spirit and scope of the present invention. Each of these embodiments and obvious variations thereof is contemplated as falling within the spirit and scope of the claimed invention, which is set forth in the following claims.

This invention may be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

As will be appreciated by one of skill in the art, portions of the invention may be embodied as a method, device, or computer program product. Accordingly, portions of the present invention may take the form of an entirely hardware embodiment or an embodiment combining software and hardware aspects all generally referred to as a “circuit” or “module.”

The present invention includes a computer program product which may be hosted on a computer-usable storage medium having computer-usable program code embodied in the medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Computer program code for carrying out operations of the present invention may be written in any programming language including without limitation, object oriented programming languages such as Java®, Smalltalk, C# or C++, conventional procedural programming languages such as the “C” programming language, visually oriented programming environments such as VisualBasic, and the like.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a non-transitory computer readable medium for providing output from one or more A/V devices, wherein the computer program is implemented by one or more processors executing processor instructions, the computer program product comprising:
a first computer code for associating output from each of the one or more A/V devices with a unique identifier;
a second computer code for receiving the associated output from the one or more A/V devices;
a third computer code for initializing wireless communication with one or more remote devices;
a fourth computer code for receiving information, from one or more remote devices, identifying the associated output from the one or more A/V devices; and
a fifth computer code for streaming the identified associated output from the one or more A/V devices to the respective one or more remote devices.

2. The computer program product of claim 1, further comprising a sixth computer code for authenticating the one or more remote devices.

3. The computer program product of claim 1, wherein the output comprises video.

4. The computer program product of claim 1, wherein the output comprises audio.

5. The computer program product of claim 4, wherein the output further comprises video.

6. The computer program product of claim 1, wherein the output further comprises data received from one or more third-party data sources.

7. The computer program product of claim 6, wherein the data received from the one or more third-party data sources includes paid advertisements.

8. The computer program product of claim 7, further comprising a sixth computer code for communicating the paid advertisements to the one or more A/V devices.

9. The computer program product of claim 1, further comprising a sixth computer code for streaming the identified associated output from the one or more A/V devices to one or more other A/V devices.

10. The computer program product of claim 1, further comprising:
a sixth computer code for receiving closed captioning data from the one or more A/V devices; and
a seventh computer code for synchronizing and communicating the closed captioning data to the respective one or more remote devices.

11. The computer program product of claim 1, further comprising:
a sixth computer code for determining closed captioning data in at least near real-time from an audio stream of the associated output from the one or more A/V devices using speech to text algorithms; and
a seventh computer code for synchronizing and communicating the closed captioning data to the respective one or more remote devices.

12. A system for providing output from one or more A/V devices, the system comprising:
a plurality of remote devices;
a media device in communication with the one or more A/V devices;
a network interface in communication with the media device and the plurality of remote devices over a wireless network, the wireless network interface being configured to provide output from the one or more A/V devices;
a shared database in communication with the communication device;
wherein the media device is configured to:
associate output from each of the one or more A/V devices with a unique identifier,
receive the associated output from the one or more A/V devices;
initialize wireless communication with one or more remote devices;
receive information, from one or more remote devices, identifying the associated output from the one or more A/V devices; and
stream the identified associated output from the one or more A/V devices to the respective one or more remote devices.
